(19) United States
(12) Patent Application Publication
(10) Pub. No.: US 2002/0101603 A1
(43) Pub. Date: Aug. 1, 2002

(54) Method and apparatus for embodying documents

(76) Inventors: Athena Christodoulou, Bristol (GR); Richard Taylor, Bristol (GB); Christopher Tofts, Halifax (GB)

Correspondence Address: IP Administration, C/o Hewlett-Packard Company, 3404 East Harmony Road Mailstop 35, Fort Collins, CO, 80528-9599, US

(21) Appl. No.: 09/940,615

(22) Filed: Aug. 29, 2001

(30) Foreign Application Priority Data
Jan. 31, 2001 (GB) 0102415.7

(51) Int. Cl. G06F 15/00

(52) U.S. Cl. 358/1.14

(57) ABSTRACT

Conflict between contemporaneous print jobs in an in information technology network is resolved by providing each print job with a priority value. A print manager determines whether a requested job has a higher priority than a current job, and interrupts the current job as appropriate. Data processed in the current job at interrupt is either stored if space is available, or dumped if space is not.

### BACKGROUND TO THE INVENTION

1. Field of the Invention

The present invention relates to the conversion of source data into a document, such as for example, the printing of a document on paper or some other readable medium, from source data such as an electronic data file. A typical example of a source data file representing a document is an electronic data file, created using a word processing program, and which may be embodied by printing onto paper, or display on a computer monitor, for example.

In this specification the term “document” is intended to be interpreted broadly, to encompass within its scope any assimilable manifestation of source data. Thus a “document” may be embodied for visual assimilation (printed on paper, displayed on a monitor), aural (on audio tape) or tactile assimilation (e.g. the printing of Braille), and while printing of a document may indicate one manner in which a document may be embodied (i.e. on tangible “hard” media such as paper), it is not the only way of creating a document from a source data file. The process of converting source data into a document varies widely in dependence upon what is known as the “device implementation” of the source data, that is to say the genus of document to be created (e.g. visual, or tactile), and the specific parameters of the medium on which the document is to be embodied (e.g. in the case of printing, large paper, small paper, etc . . . , or even printing on some other medium such as for example a carpet).

2. Description of Related Art

In the case of printing source data onto paper (or some other printable medium), it is known to connect one or more elements of computing capability (e.g. elements which include both processing and storage capability in any form—e.g. shift registers—being classifiable as either a storage element, or part of a processor) to an electromechanical device adapted to deposit ink onto paper, known in the art as a print engine, in order to produce a printed document. There are a number of different genera of print engine. One genus comprises a print-head supported on a carriage adapted to move laterally relative to an advancing page, so that marks may be deposited on any part of the page by a suitable combination of a lateral motion of the carriage and forward motion of the page. The majority of printers of this type deposit visible indicia on a page, and so are colloquially known as an “inkjet” printer. A further genus, known as a “laserjet” printer has a rotating drum upon which ink (which as indicated above is intended to encompass toner and any other substance which may be used to create indicia, regardless of whether such indicia are visible in certain types of light) is deposited in a predetermined pattern by means of the use of electrostatic charge and a laser; subsequent contact between the surface of the drum and a page deposits the ink from the drum onto the page. In each case operation of the elements of the print engine is controlled by means of the computing elements to which they are connected, with the quality and speed of printing being dependent not only upon the print engine, but also on the operation and capability of the computing elements. Typically the various computing elements which are required in order to: (a) create a source data file; (b) transform the source data file into a set of instructions useable for controlling the print engine; and (c) control the print engine in accordance the aforementioned instructions, are distributed between different physical locations. Some are packaged with the print engine, others with a desktop computer, for example. In commercial vernacular the appliance which includes the print engine is known as a printer, regardless of how much or little computing is performed by any computing elements which may be packaged with the print engine, and operations which are performed in order to produce a printed document from, for example, a document prepared using a word processing package are known as the “print pipeline”.

In contemporary information technology, printers and computers are frequently part of a network of, inter alia, one or more other printers and computers, all of which are either interconnectable or interconnected. Thus a user (whether a human user, or computing entity) working at a particular computer will frequently have a choice of a number of printers to use in order to perform a particular print job. The selection the user makes may depend, for example, upon the size of the job, the desired quality of the job and the speed with which the job is required; in addition the user's choice may also be influenced by the availability of a particular printer and it's physical proximity.

### SUMMARY OF THE INVENTION

A first aspect of the present invention relates to the appreciation that an information technology network which includes a plurality of printers has, intrinsically, a potential printing capacity which exceeds the currently achievable actual printing capacity when operated in accordance with existing methods. Accordingly, a first aspect of the present invention provides a method of printing a document in an information technology network comprising at least one computer and at least one printer, the method comprising the steps of:

dispatching first source data having a first printing priority to at least one printer for performance of at least one print process;

subsequent to dispatch of the first source data and prior to completion of the at least one print process, dispatching second source data having a second printing priority to the at least one printer for performance of at least one print process;

determining whether the second priority is greater than the first priority;

if the second priority is higher than the first priority, interrupting the at least one print process on the first source data, and either: (i) storing any processed first source data on long-term storage within the network, or (ii) deleting any processed first source data from any ephemeral storage of the at least one printer to which first source data was dispatched without storing such processed first source data on long term storage within the network, and returning a message to a print manager to that effect.

In a preferred embodiment, any processed first source data is stored on long-term storage of at least one printer of the network in the event that the available storage space is sufficient, and any processed first source data is deleted from any ephemeral storage of the at least one printer to which first source data was dispatched without storing such processed data on long term storage in the event that the available storage space is not sufficient.

The present invention has substantial benefits in an environment of a plurality of printers, and accordingly in a further preferred embodiment the first and second source data is distributed between first and second pluralities of printers respectively for performance of the at least one print process, and where the first and second pluralities of printers have at least one printer in common.

The print process may be any one of the computational or electromechanical steps that are required in order to convert source data into a document having indicia, such as visible indicia (e.g. letters of the alphabet) on an recording medium, such as paper, or acetate slides for a presentation, for example.

A further independent aspect of the present invention provides a printer comprising: a print operations function including a print engine and feed and finishing capability, a processor, at least one data storage medium, and at least one network port to enable connection of the printer to elements of an information technology network, wherein the processor is adapted to execute a suspension function which includes the steps of: (a) suspending a print process and (b) either: (i) saving any data output by the print process upon suspension thereof on long term storage, or (ii) deleting from ephemeral storage any such output data without saving such output data on long term storage.

Preferably the processor is adapted to run a program which: determines a priority assigned to incoming data entering the printer via the at least one network port for a first type of print processing; determines whether the priority assigned to the incoming data is higher than a priority assigned to current data undergoing the first type of print processing; and automatically executes the suspension function in the event that the incoming data has a higher priority than the current data.

### BRIEF DESCRIPTION OF DRAWINGS

Embodiments of the present invention will now be described, by way of example, and with reference to the accompanying drawings, in which:

FIGS. 1A-E are schematic representations of operations forming part of the print pipeline;

FIGS. 2A and B are schematic representations of an information technology network including a plurality of printers;

FIGS. 3, 4, 5 and 6 are program listings for additional functions executable within the network printers of FIGS. 2A and B;

FIGS. 7 and 8 are flow charts illustrating operation of a print management program operating in the network of FIGS. 2; and

FIG. 9 is a further flow-chart illustrating a modification of the program of FIGS. 7 and 8.

### DESCRIPTION OF PREFERRED EMBODIMENTS

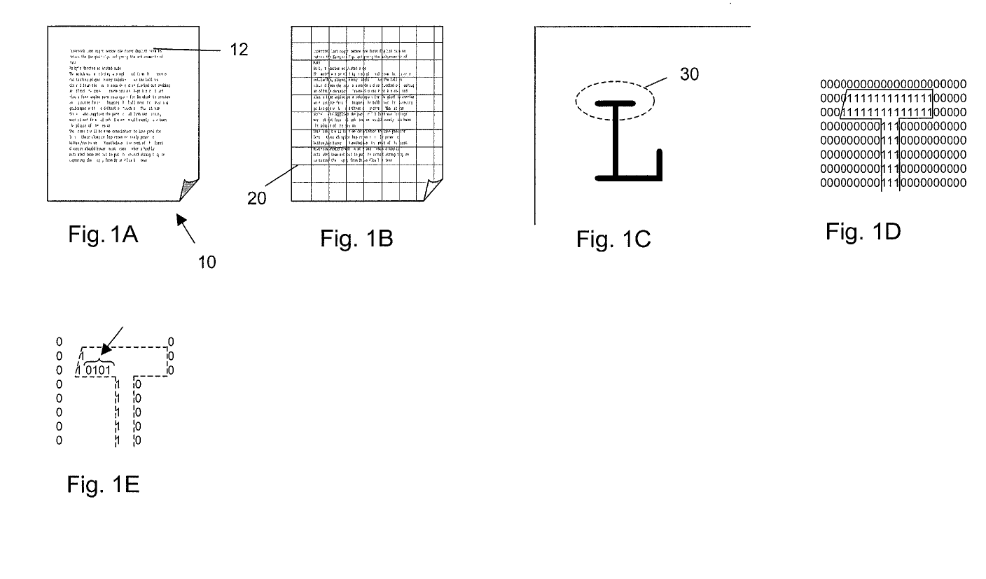

Referring now to FIGS. 1A-E, a document 10 contains lines of text 12, and both the text and its format on a page are stored within a source data file. The source data file of the document will typically be created by reference to the document itself, the creator of the source file using the document which is created in real time on a computer screen from the source file as visual feedback for the creation of the source file. Typically, for source files created using word processing programs, the form of the source file will be particular to the word processing program that is being used to create it, although as is well known in the art there are features which are common to virtually all such programs. For example, in accordance with an ASCII standard, each letter of the alphabet is represented by a number (e.g. the letter “a” is represented by the number 56); however particular characters used to represent different formats for such letters differ from program to program.

The creation of a printed document from a source data file involves a number of operations which collectively are known as a “print pipeline”. The first operation within the print pipeline is to define a visual image of the document in a computer language called page control language (PCL for short). Referring now to FIG. 1B, this involves defining a page in accordance with a predetermined size (typically determined by the creator of the source file), and dividing the page into a grid of boxes 20, each of which contains a relatively small amount of text. The provision of a representation of the document in PCL may be described in simple terms as breaking the page down into manageable chunks, themselves defined by the boxes 20 of the grid.

Referring now to FIGS. 1C and D, each of the individual grid boxes 20 is then subject to a process known in the art as ripping. Ripping is effectively a raster scan of a grid box 20, the result of which is that the text in the box is represented as an electronic digital array of a series of“1”s and “0”s. Thus the seraph of the capital “L” highlighted within the dashed ellipse 30 in FIG. 1C is seen represented by an array of “1”s against a background of “0”s as illustrated in FIG. 1D (an outline being shown for emphasis only). The resultant digital array (or “bitmap”) of numbers is then used directly to instruct the print engine where to deposit ink on a page, i.e. in the representation of FIG. 1D it is intended that ink is to be deposited by the print engine wherever there are “1”s, with the spacing between adjacent bits typically being equal to the smallest indexing movement of the print engine which is repeatably achievable. An intrinsic characteristic of the ripping process is that because of the volume of processing operations required it is not possible to determine in advance the amount of time required to rip a given PCL file. Following ripping, the ripped data is stored, typically on one or more of the storage elements of the printer which is performing the printing. The ripped data is typically stored because, given the relatively large processing time, it is desirable to perform ripping of a document only once, and it frequently occurs that the print engine is not able to act upon the ripped data in real time, e.g. because it is busy, or simply because it is not able to operate sufficiently fast to keep up with the ripping process. However storage of ripped data creates a further problem, because of the relatively large volume of data produced by the ripping process; the better the ripping process in respect of a given document the larger quantity of data that is produced, and as with the time required to complete a ripping operation, it is not possible to determine in advance the amount of data which will be produced by ripping process (there usually being an ephemeral requirement during the course of the ripping process for more disk space than simply the amount of disk space used to store the end result of the ripping process). It is thus necessary to compress the ripped data prior to storage, and an example of compressed ripped data is illustrated in FIG. 1E. The compression routine defines, for each row, the first bit of a section of the row where all subsequent bits are of the same type, and adjacent to that first bit, a binary number equal to the number of identical bits that follow in that row. Thus for example, the first bit of an exemplified part of a row in FIG. 1E is a “1”, and is followed by the number “0101” (the number “10” in binary), indicating that 10 further bits of value “1”’ follow, thus constituting a saving of 6 bits stored (the ten bits that would have been stored in the absence of compression, less the four that are required in order to indicate the presence of these ten in uncompressed data).

In connection with the print pipeline described above, it should be noted that the form of source data is to an extent dependent upon perspective. Thus for example, from the perspective of preparing the PCL file, the source data will be the file created by the word processing program used to create the source data. However, from the perspective of the ripping operation, the source data may be regarded as the PCL file.

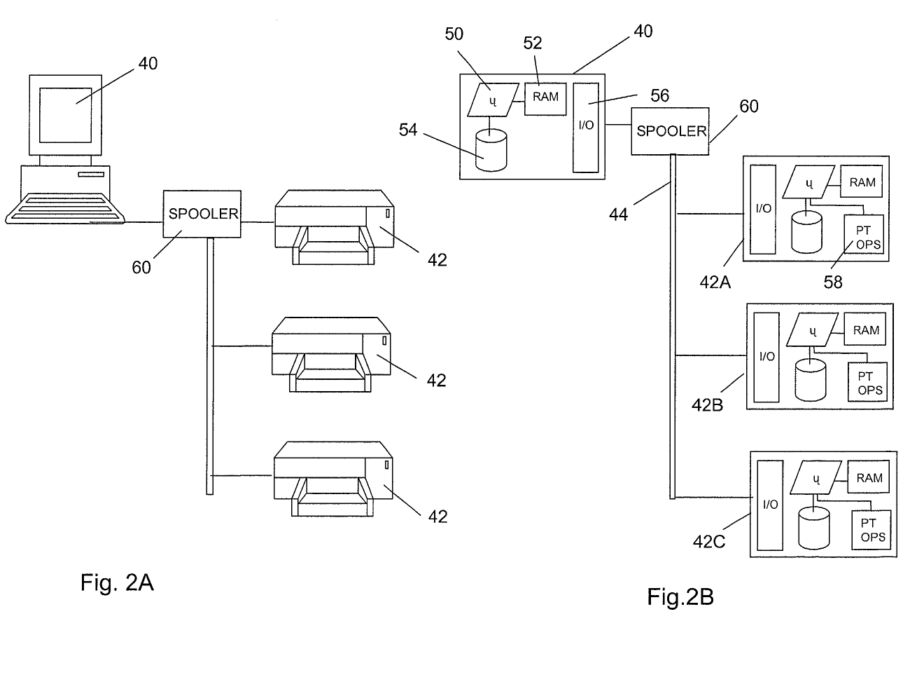

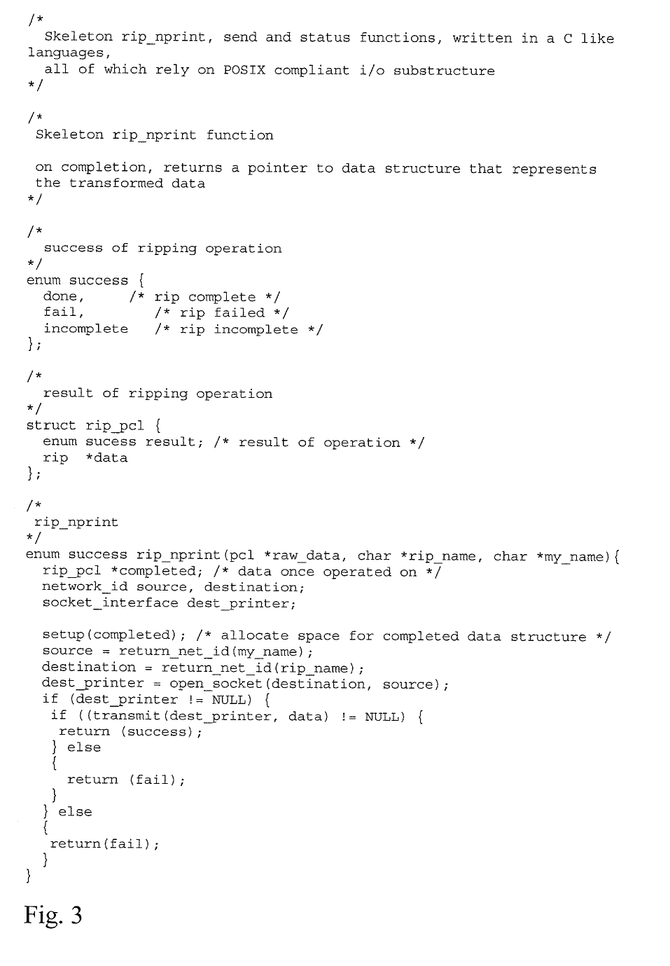

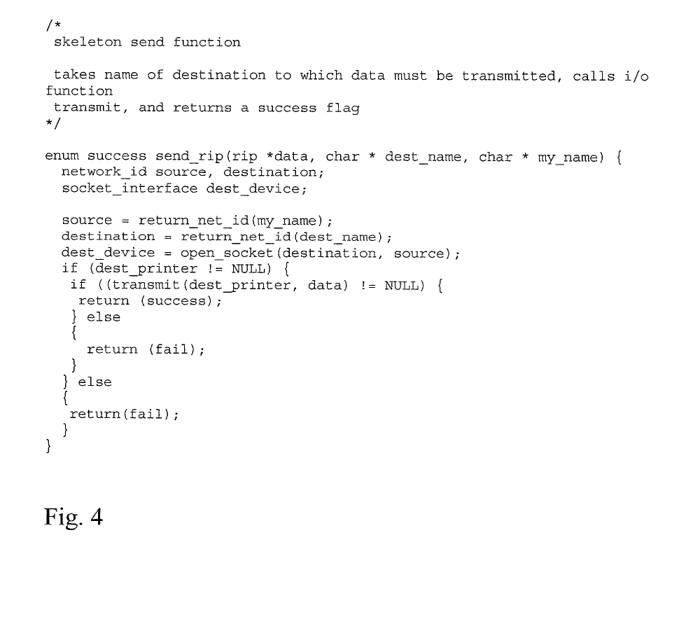

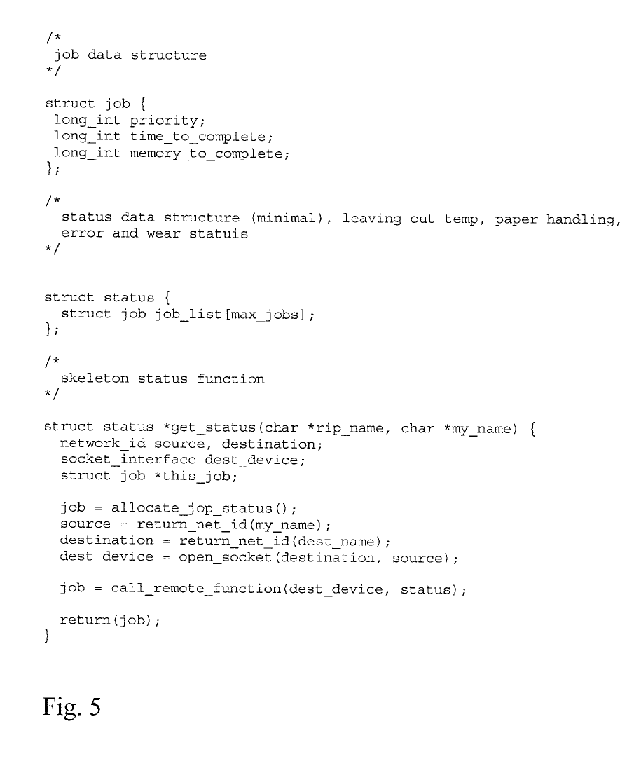

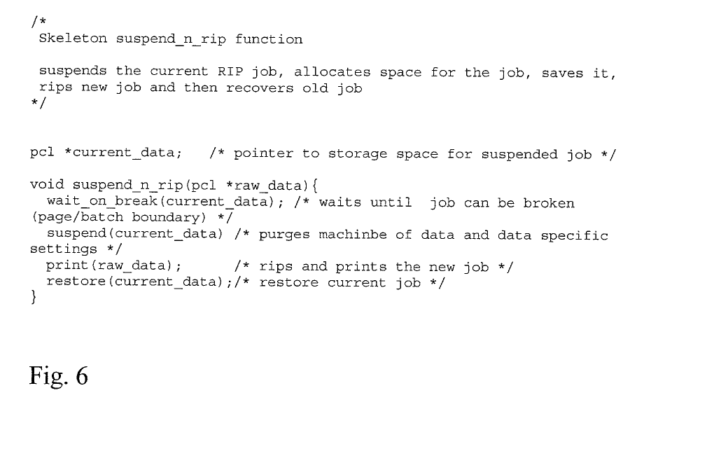

Referring now to FIGS. 2A and B, the network of hardware elements for performing the operations thus far described includes a standard desktop PC 40, and a plurality of printers 42, all of which are interconnected via network links 44. The computer 40 and printers 42 include similar computing hardware elements, including in each case a processor 50, RAM 52, hard disc storage 54 and an input/output function (including LAN card, etc., as appropriate) 56, which will typically include a USB port. In addition, each of the printers 42 have the mechanical elements necessary for performing printing operations, i.e. a print engine, together with feed and finishing elements, all of which are represented schematically by the designation “Pt Ops”, and having the reference numeral 58. A network element known as a spooler 60, which has the function of acting as a data buffer between the computer and the printers is also provided, and comprises a storage disk and processor (not shown). Spoolers and their function are known per se and shall not be discussed further.

While existing printers have hardware which is similar from a functional point of view to that of computers, typically the hardware is configured, whether by application or system software, such that its capabilities are somewhat different to those of a computer. For example each of the printers will be equipped with what is, from a functional perspective, relatively standard application software, whose purpose is the performance of ripping, compression, and storage operations. In addition, each printer will also be provided with system software, typically stored on the hard disc storage 54, to enable the printers to receive and process relatively large volumes of data (e.g. documents to be printed), and to send status information regarding the progress of a particular print job (or, in the case of an “error” message, the lack of such progress). A typical print operation involving the elements of the network described above operating in their usual (i.e. prior art) manner involves the dispatch to a particular printer of a source data file, which the printer in question then processes in the manner described in relation to FIGS. 1 A-E above. During the course of this procedure, the printer is adapted to send back status information to the controlling computing entity regarding the number of pages processed and printed, or, in the event of a problem with the printing operation, an error message. For the purpose of simplicity it will be assumed in the subsequent illustrated example that management of all printing operations within the illustrated network is performed exclusively by a it program running in computer 40, and which will hereinafter be referred to as the print manager. Thus, in this example the only instructions that the printers 42 will receive will be from the print manager. In practice other computers forming part of the same network are likely to make printing demands upon the printers 42, and the manner in which this complication may be taken into account will be discussed subsequently.

In accordance with one aspect of the present invention, it is provided that what may be termed the “latent” computing capability of each of the printers be made available to ameliorate bottlenecks in the print pipeline. Each of the printers 42 is provided with auxiliary system software, which in the illustrated embodiment essentially amounts to the following functions which are executable within each of the three printers within the network.

### RIPNPRINT

a function executable within each of the printers within the illustrated network, and in accordance with which a printer rips data in the message accompanying the command which causes execution of the function, but does not pass the ripped data to the print ops. to create a printed document.

### SEND

A function, execution of which causes a to send data specified in the corresponding command to a specified network location or locations.

### GETSTATUS

A function according to which a given printer returns specific status information including number of jobs currently in the queue, priority of jobs currently in the queue, aggregate size of jobs currently in the queue, expected execution time for the given printers current jobs, instantly available storage space, and storage space allocated to jobs of one or more specified priorities.

### SUSNSAVE

A function according to which a printer interrupts any processing of the current print job, either saves the data thus far processed, or dumps the data and returns a status flag to indicate which of these has occurred.

With appropriate use of the RIPNPRINT, SEND and GETSTATUS functions, it is possible, for a given print job, to distribute the burden of processing the job, such as for example to distribute the burden of ripping the data in a PCL file between printers in a network, even though the entire job is to be passed through the print ops. of a single printer. Control of the process by means of which jobs are distributed for processing throughout the network is achieved by a print management program, the operation of which in this respect is described in our co-pending European Patent application, filed on the same day, and having applicant's docket 30006580, the contents of which are hereby incorporated by reference, and which will not be described further herein.

In addition to controlling the distribution of print process tasks between printers of the network, the print management program (print manager) additionally governs any conflict between concurrently requested print jobs, in accordance with a predetermined rule set. In the present example the rule set as follows:

(1) no job is allocated to a printer without an accompanying priority;

(2) a job may be interrupted to accommodate a job of higher priority.

Other more complex rule sets may be implemented as desired, providing for example specific circumstances under which one priority level may prevail over another, such as circumstances depending upon printer capability.

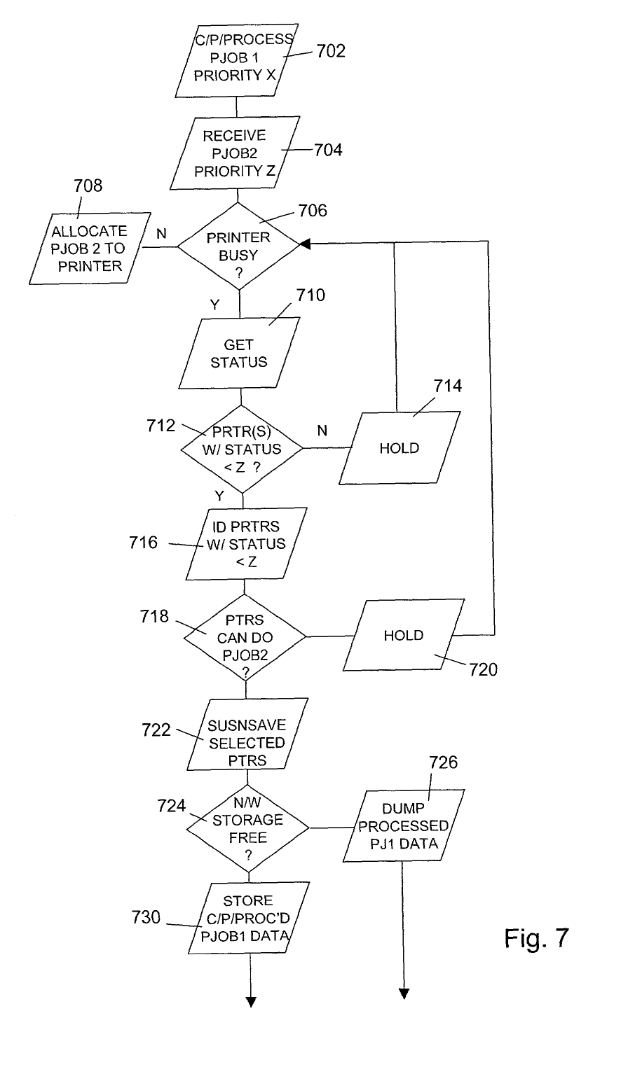

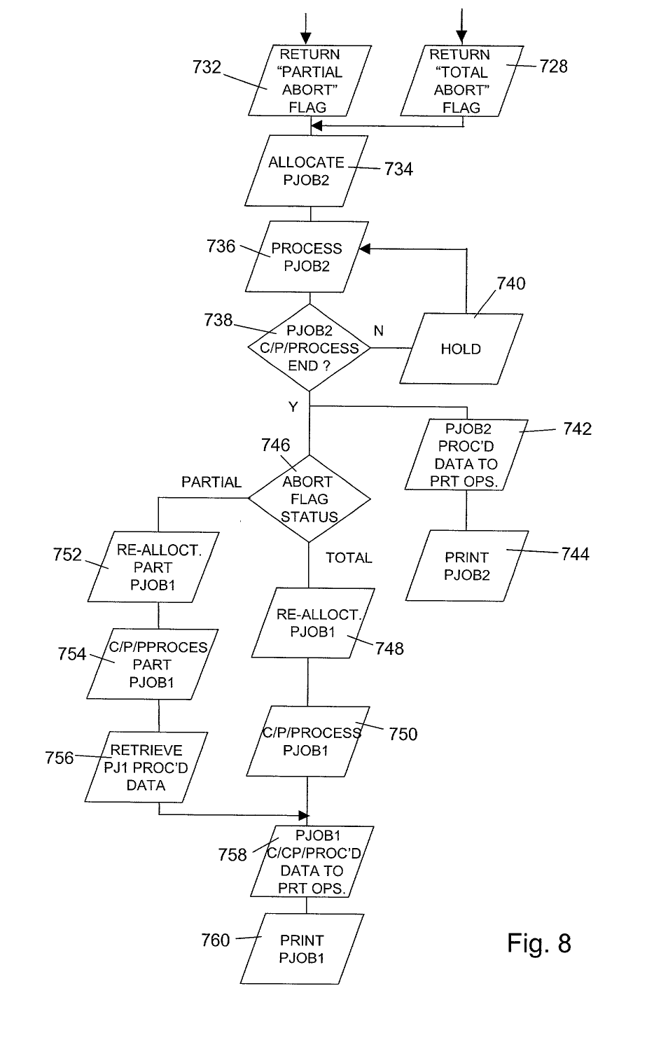

Referring now to FIGS. 7 and 8, an example of the operation of the print manager according to the present invention will now be illustrated. In the present example the print manager program runs within the computer 40. However, as discussed in our above-referenced co-pending European patent application, the print manager may be located elsewhere within the network, such as within a spooler 60, or within one of the printers 42. The print manager may also be distributed to the extent that one or more of the processes described herein are controlled by other computing entities than that on which the print manager runs. The process starts at step 702 with computational processing of a print job PJOB1, having an associated priority given by priority value X; in practice it is likely that more than a single print job will be processing (whether computationally or passing through the print ops) at any given moment, however for the purpose of simplicity the present example illustrates only a single job. Concurrent with the processing of PJOB1, the print manager receives, at step 704, a further requested print job, PJOB2, having a priority Z. In receiving the request for PJOB2, the print manager also receives all of the source data necessary to execute PJOB2, and this is stored on long term storage specially designated to the print manager, and which is usually, though not necessarily located in the same computing entity on which the print manager is running. At step 706, following a step not illustrated of determining the most advantageous printer requirements for PJOB2, the print manager determines whether the or each printer within the network which would be necessary for the best possible processing of PJOB2 are busy; if they are not, then at step 708 the print manager simply allocates PJOB2 to the or each appropriate printer. As mentioned above, typically, as disclosed in our above-referenced co-pending European patent application, the computational print processing (c/p/processing) steps such as ripping are performed at a plurality of printers within the network, and the ripped data is then passed to the print ops. of a single printer for the quasi-mechanical steps of marking a medium such as paper with indicia (e.g. letters of the alphabet using toner). In the event that the printer(s) required to process PJOB2 are busy, the print manager then issues a GETSTATUS command at step 710 to each printer within the network, causing the GETSTATUS function to execute, and according to which each of the printers returns status data relating to its contemporaneous operational state. Following receipt of the status information, at step 712 the print manager determines whether any of the printers are executing a job of lower priority than priority Z (an idle printer will return a further priority indicator indicative of an idle state). If there no printers return a priority lower than Z, then according to the rule set to which the print manager is operating, PJOB2 is not able to take priority over an currently processing print job, and the process goes into a hold step 714, which then returns the process to step 706. If one or more printers return a priority lower than Z (which in the present simplified example they will since we have defined the only other concurrent print job PJOB1 priority X to have a lower than priority Z), at step 716 the print manager identifies which printers have returned such a priority. At step 718 the print manager determines which, if any of these printers are qualitatively appropriate for processing of PJOB2 (e.g. because of the particular characteristics of the printer in relation to such issues as finishing calibre of the job, whether the job requires colour printing, etc.), and then determines whether the identified appropriate printers are quantitatively able to process PJOB2 (e.g. because of their intrinsic capacity, such as the amount of paper that they have available—known to the print manager from execution of the GETSTATUS command). If the available printers are unable to process PJOB2, then the process goes into a holding step 720, which then returns the process to step 706. If the available printers are able to process PJOB2, then at step 722 the print manager selects the most appropriate printers from those available (in the event that such a choice exists), and issues SUSNSAVE commands to them.

Upon receipt of the SUSNSAVE command, each of the printers thus instructed suspends the print job that it is currently working on (which in the present simplified example is PJOB1). At step 724 the print manager determines whether there is sufficient long term storage capacity within the network, i.e. within the printers of the network and possibly also the computer 40, to store processed PJOB1 data which has thus far been produced (this step is an example of a print management step which may be distributed, i.e. both controlled and executed, by an entity remote from the “main” print manager). If there is insufficient long term storage space within the network then at step 726 both processed PJOB1 data and unprocessed PJOB1 data is deleted from ephemeral storage (i.e. storage such as cache, in which data is held for the purpose of enabling processing to take place upon it), and a “TOTAL ABORT” flag is returned at step 728 (in the event that any PJOB1 source data is held in long term storage of one or more printers, this is also deleted in the event that the ephemeral storage is cleared of PJOB1 data without re-storing the data on long term storage). As mentioned above in relation to PJOB2, the source data for PJOB1 is retained in long-term storage dedicated to the print manager until the job is completed, at which point it is deleted. If sufficient long term storage is available, the processed PJOB1 data is stored at step 730, and the unprocessed PJOB1 data deleted from ephemeral storage, following which a “PARTIAL ABORT” flag is returned at step 732, together with an indicator as to the position of the abort (i.e. which of the source data of PJOB1 still requires c/p/processing), and the location of the stored data within the network.

Having now liberated the necessary printers by interrupting PJOB1, the print manager then allocates PJOB2 to those printers (i.e. sends the source data to them) at step 734, and PJOB2 then undergoes c/p/processing at step 736, a process which is executed by the printers. At step 738 the print manager determines whether PJOB2 c/p/processing has finished; if it has not, then the process goes into a hold step 740 which subsequently returns to step 736; if the processing has finished then at step 742 the print manager sends the now computationally processed PJOB2 to the print ops., where at step 744 is it printed.

Simultaneously, the print manager investigates the abort flag status for the interrupted PJOB1 at step 746. If the status was a total abort, then the entire PJOB1 is re-allocated at step 748, and at step 750 undergoes c/p/processing. If the status was a partial abort, then at step 752 the print manager re-allocates the part of PJOB1 which had not, at the time of issuing the SUSNSAVE command, been processed (as determined from the partial abort flag status message), and at step 754 this is computationally processed. At step 756 the print manager retrieves the PJOB1 processed data. At step 758 PJOB1 is passed to the print ops., where at step 760 it is printed.

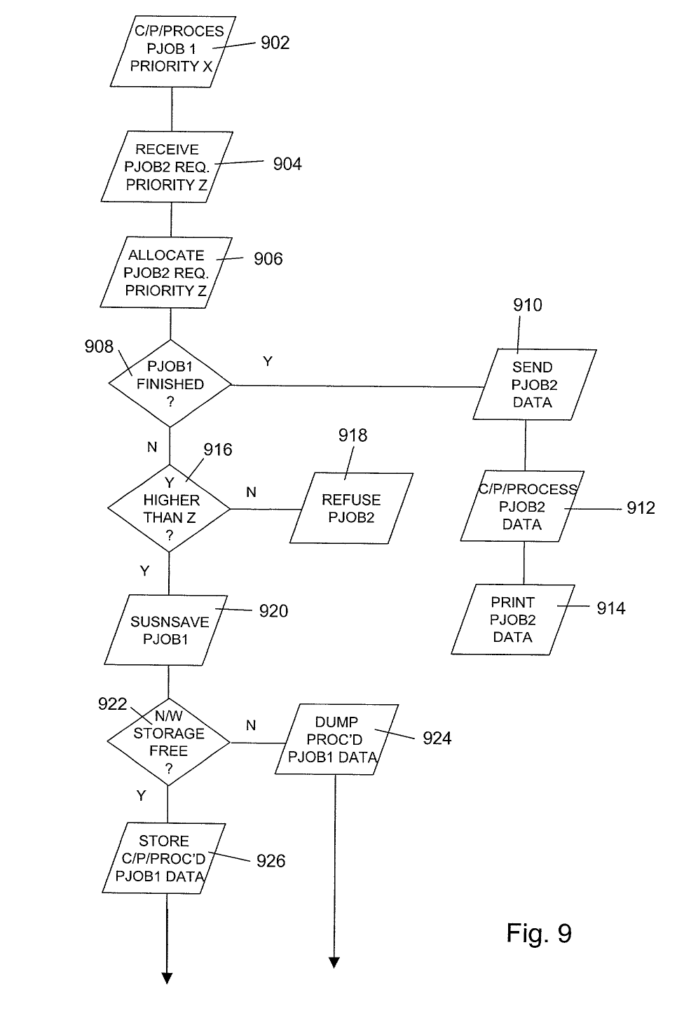

In a modification of the print manager described above, job requests are passed automatically to one or more printers as appropriate, which then prioritise their workload. Referring now to FIG. 9, a job PJOB1 is computationally print processing at step 902, when at step 904 the print manager receives a print job PJOB2. Without determining the status of the network printers, the print manager allocates a job request at step 906 to the printers within the network which are intrinsically most appropriate for the job, and which are contemporaneously c/p/processing PJOB1. At step 908 the printers then determine whether they have finished c/p/processing PJOB1; if this is finished, then return status information to that effect, and at step 910 the source data for PJOB2 is sent to the printers, which c/p/process PJOB2 at step 912, and at step 914 the job is passed to the print ops.. In the event that the printers determine that PJOB1 is not finished, a determination is then made at step 916 whether the priority of PJOB2 is higher than that of PJOB1; if it is not, then the printers return an indicator to the print manager at step 918 that they are refusing PJOB2, in which case the print manager does not allocate PJOB2; if the priority of PJOB2 is higher than PJOB1, then at step 920 the printers automatically execute the SUSNSAVE function to suspend c/p/processing activity on PJOB1. This is then followed by steps 922 to 926, which are identical to steps 724, 726 and 730 respectively, following which the process continues as set out and described in relation to FIG. 8 above.

As mentioned above, a simple rule set has been employed as a method of determining the order of allocated jobs, but alternative rule sets are possible. One rule set provides priorities based, inter alia, on job completion time. With such a rule set future predicted printer performance is taken into account. For example, whether the printer believes that it is capable of operating beyond completion of a current job may be considered; in the event that it does not predict continued operation beyond the current job, interruption of the current job for a job of ostensibly higher priority would not be an optimal use of resources, because according to predicted printer performance, the higher priority job would not be printable on that printer or printers.

1. A method of printing a document in an information technology network comprising at least one computer and at least one printer, the method comprising the steps of:
dispatching first source data having a first printing priority to at least one printer for performance of at least one print process;
subsequent to dispatch of the first source data and prior to completion of the at least one print process, dispatching second source data having a second printing priority to the at least one printer for performance of at least one print process;
determining whether the second priority is higher than the first priority;
if the second priority is higher than the first priority, interrupting the at least one print process on the first source data, and performing one of:
(i) storing any processed first source data on long-term storage within the network;
(ii) deleting any processed first source data from any ephemeral storage of the at least one printer to which first source data was dispatched without storing such processed first source data on long term storage within the network;
and;
returning a message to a print manager to that effect.

2. A method according to claim 1 further comprising the step, prior to the step of either storing or deleting any processed first source data, of determining how much long-term storage space is available in the network.

3. A method according to claim 2 further comprising the step of determining whether the available long term storage space is sufficient to enable storage of any processed first source data and subsequent performance of the at least one print process on the second source data.

4. A method according to claim 3 wherein any processed first source data is stored on long-term storage of at least one printer of the network in the event that the available storage space is sufficient, and any processed first source data is deleted from any ephemeral storage of the at least one printer to which first source data was dispatched without storing such processed data on long term storage in the event that the available storage space is not sufficient.

5. A method according to claim 1 wherein the step of determining whether the second priority is higher than the first priority is determined in advance of dispatching the second source data to the at least one printer.

6. A method according to claim 5 further comprising the step, in the event that the second priority is higher than the first priority, of dispatching to the at least one printer a command instructing the at least one printer to interrupt the at least one print process on first source data, and either to save any processed first source data, or to delete such processed first source data.

7. A method according to claim 1 wherein the step of determining whether the second priority is higher than the first priority is determined at the at least one printer subsequent to receipt of the second source data.

8. A method according to claim 7 further comprising the step, performed within the at least one printer in the event that the second priority is higher than the first priority, of automatically executing a command instructing the at least one printer to interrupt the at least one print process on first source data, and either to save any processed first source data, or to delete such processed first source data.

9. A method according to claim 1 wherein any processed first source data is stored on long term storage provided by a plurality of printers within the network.

10. A method according to claim 1 wherein first and second source data is distributed between a plurality of printers for performance of the at least one print process, and the at least one print process includes ripping of first and second source data.

11. A method according to claim 10 wherein the first and second source data are each dispatched initially to a single printer, and are subsequently distributed between a plurality of printers.

12. A method according to claim 10, wherein the first and second source data is distributed between first and second pluralities of printers respectively for performance of the at least one print process, and wherein the first and second pluralities of printers have at least one printer in common.

13. A method according to claim 12, wherein the second priority is higher than the first priority, and the method further comprises the steps, prior to dispatch of the second source data, of estimating which printers involved in performing the at least one print process on the first source data will have long term storage available after storage of any processed first source data upon interruption of the at least one print process on the first source data, and dispatching at least part of the second source data to at least one printer thus identified.

14. A method according to claim 1 wherein the print process may be a computational print process, or a print process in which data is passed through print ops. of a printer to place indicia on a medium and thereby produce a document.

15. A printer comprising: a print operations function including a print engine and feed and finishing capability, a processor, at least one data storage medium, and at least one network port to enable connection of the printer to elements of an information technology network, wherein the processor is adapted, upon receipt of an appropriate signal, to suspend a print process taking place within the printer and to perform one of the following operations:
(i) save any data output by the print process upon suspension thereof on long term storage;
(ii) delete from ephemeral storage any such output data without saving such output data on long term storage.

16. A printer according to claim 15 wherein the processor is adapted to run a program which: determines a priority assigned to incoming data entering the printer via the at least one network port for a first type of print processing; determines whether the priority assigned to the incoming data is higher than a priority assigned to current data undergoing the first type of print processing; and automatically executes a suspension function in the event that the incoming data has a higher priority than the current data.

17. A printer according to claim 15 wherein the processor is adapted to execute the suspension function upon receipt of a corresponding command via the network port.

18. A printer according to claim 15 wherein the long-term storage is within the network.

19. A printer according to claim 19 wherein the long-term storage is the at least one data storage medium.

20. A method of printing a document comprising at least one computer and at least one printer, the method comprising the steps of:
dispatching first source data having a first printing priority to at least one printer for performance of at least one print process;
subsequent to dispatch of the first source data and prior to completion of the at least one print process, dispatching second source data having a second printing priority to the at least one printer for performance of at least one print process;
determining whether the second priority is higher than the first priority;
if the second priority is higher than the first priority, interrupting the at least one print process on the first source data, and performing one of:
(i) storing any processed first source data on long-term storage;
(ii) deleting any processed first source data from any ephemeral storage of the at least one printer to which first source data was dispatched without storing such processed first source data on long term storage; and
returning a message to a print manager.
